(19) United States
(12) Patent Application Publication
(10) Pub. No.: US 2026/0249724 A1
(43) Pub. Date: Aug. 27, 2026

(54) METHOD AND DEVICE FOR CONNECTING A CONNECTOR OF AN ELECTRIC VEHICLE CHARGER TO A SOCKET OF AN ELECTRIC VEHICLE

(71) Applicant: Rocsys B.V., Rijswijk (NL)

(72) Inventor: Dies Martin Mulder, Haarlem (NL)

(21) Appl. No.: 19/114,745

(22) PCT Filed: Sep. 28, 2023
(86) PCT No.: PCT/EP2023/076828

§ 371 Date: Mar. 24, 2025

(30) Foreign Application Priority Data
Sep. 30, 2022 (NL) 2033207

(51) Int. Cl. B60L 53/35; B60L 53/16

(52) U.S. Cl. CPC B60L 53/35; B60L 53/16

(57) ABSTRACT

Device for connecting a connector of an electric vehicle charger to an electric vehicle socket, comprising a stationary member that forms part of a fixed world and/or the vehicle charger and/or an actuated mechanism, a non-stationary member for carrying a connector, that is displaceable with respect to the stationary member along respective lines substantially parallel to each other by means of both an actuated displacement from a default position to an actuated position and a superimposed compliant displacement from the actuated position to an actual position, at least one controllable actuator for accomplishing the actuated displacement, a compliance assembly for accomplishing the compliant displacement, a controller assembly, for controlling the controllable actuator, determining the actual position, and/or determining the compliant displacement of the non-stationary member and for taking an intervening action when the compliant displacement exceeds a first threshold which first threshold is a non-constant function of the actuated position.

### FIELD OF THE INVENTION

The present invention relates to a device and to a method for connecting a connector of an electric vehicle charger to a socket of an electric vehicle.

### BACKGROUND OF THE INVENTION

The process of charging an electric vehicle generally requires the manual connection of a cable charger to the vehicle's socket.

Several developments have been made in the previous years through which actuated mechanisms, such as robots, can be used to facilitate the support, movement and connection of a charger to an electric vehicle's socket. Actuated mechanisms currently known in the art are able to locate the position of an electric vehicle's socket and direct and plug the charger's connector to the socket without intervention of an operator.

Actuated mechanisms for the charging of an electric vehicle, also referred herein as “electric vehicle charging robot, or simply “robot” generally comprise many distinct components, such as actuators, compliance mechanisms, data capturing devices, and computer processors that control the operation of all the peripherals of the robot. Computer processors may be connected through communication devices which allow the robot to be operated in response to certain data input.

Generally speaking, robots for the charging of electric vehicles include a housing, a protruding section actuated by an actuated device and a portion that holds or integrates the charger and positions it into the vehicle's socket. The process of plugging a connector into the socket of an electric vehicle includes different phases, depending on the particular features of the robot and the vehicle. The process generally includes the monitoring of the position of the electric vehicle's socket, the positioning of the robot in the closer vicinity of the electric vehicle's socket and the insertion of the connector into the socket, the charging, and the retrieval of the connector.

An electric vehicle charging robot may experience several disruptions before, during and after the connection of the charger to the socket of the vehicle. A disruption before the connection may include the presence of humans, who may come in physical contact with the robot either by their own movement or by movement of the robot or objects along the path of the robot that may obstruct its movement, as well as unforeseen parts of the vehicle. While the connector is plugged into the socket (or even when it gets closer to it), further disruptions may affect the process of plugging the connector into the socket, such as passengers getting on or off the vehicle, the loading and unloading of luggage, external shocks, vibrations, or the misalignment of the connector, which may result in clamping or at times getting stuck in the socket.

The above disruptions are generally disadvantageous and they can cause harm to both humans, objects and the charging infrastructure (i.e. the connector, cable, robot and charger).

### BRIEF DESCRIPTION OF THE PRIOR ART

Certain solutions have been described to address the technical problem herein described. Most of the solutions of the prior art rely on an active control, i.e., software based, such as a vision-based control which uses information gathered from a visual sensor to control the motion of the robot or sensor-based control, whereby a processor acquires sensor information and adjusts the activity of the robot based on that feedback. Other types of active control include the software-based adjustments of the robots actions when exceeding a compliance limit depending on the force that the robot is designed to apply at a particular stage of the process, e.g., positioning versus mating.

However, such techniques can be prone to errors, rely on a communication interface and may not ensure the robot to respond to a disturbance fast enough (f.e. for some implementations in “real time”). In certain circumstances, a glitch during the use of a robot for the autonomous charging of an electric vehicle can have serious consequences, such as the occurrence of a significant injury to the operator of the charging station or a damage to the car and surrounding infrastructure. Thus, due to the high level of performance needed for the software of fully autonomous charging of EV's to be certified for consistent and adequate performance, these type of implementations tend to be significantly expensive and difficult to escalate, which in turns may make the use of autonomous charging solution limited in many situations.

Other solutions aim to provide the robot with added flexibility by means of the introduction of additional compliance mechanisms to soften any unpredicted impact, however, such approach may not entirely solve the issue. For instance, while the robot is being positioned closer to the socket prior to initiate the connection, the force that the robot may exert on an object through the connector it is wielding is generally low. For the robot to effectively complete the insertion of the connector into the socket, a determined force should be exerted, which in most cases should be large enough to overcome the friction generated between the connector and the socket. Thus, due to the different forces that may be applied by the robot at different stages of the connection process, actuated mechanisms known from the state of the art may not entirely address this technical problem.

Document WO 2014 015 991 A2 describes a charging system and method for electrically charging a motor vehicle, including a control system and force determination sensors, wherein a controller communicates with the force detection means and actuates the robot guided plug to the mating plug based on a plug connection force determined by the force detection means. The control system according to this document can interrupt or modify the plug-in movement if a force detected by the force detection means, which acts on the plug, exceeds a threshold value, in particular a pre-definable threshold value. In order to achieve this pre-definable threshold value, the control means controls the robot such that it connects the robot-guided plug to the mating plug, or is configured, in particular by means of a program.

Other prior art documents describe methods for the connection of a connector of an EV vehicle, the method comprising different phases, such as a positioning phase, a connecting phase and a charging phase, wherein different forces may be applied on external bodies, and therefore different compliance threshold values are required. These prior art documents may still require having predetermined compliance intervention values which are determined by an electronic control system which is loaded with a software which is further executed by the processor of the electronic controller. Any deviation from the intervention values is monitored by the control system whereby a compliance can be either neglected or acted upon. These type of methods require therefore the predetermination of thresholds, which are monitored and acted upon through software means.

Accordingly, there remains a need for improved, yet simplified and reliable devices systems and methods which rely on a hardware implementation, for the autonomous charging of electric vehicles that can delivery enhanced safety, implementation, and ease of use. It is therefore a goal of the present invention to provide a device and method for connecting a connector of an electric vehicle charger to a socket of an electric vehicle that take away the disadvantages of the prior art.

### SUMMARY OF THE INVENTION

A general object of the present invention is to overcome the above-mentioned problems. More particularly, the present invention aims to provide an improved device, such as an actuated device and a method for connecting a connector of an electric vehicle charger into a socket of an electric vehicle, wherein the device includes a controller assembly that is able to take an intervening action when the device faces a disruption in the connecting process. It is furthermore an object of the invention to provide a device and method that allows a controller assembly to take an intervening action based on the stage of the connecting process. It is preferable that the device and method of the invention are implementable by a hardware and may not require a software controllable controller to control its essential functions.

According to the present invention, this general object is achieved by a device comprising components accomplishing and/or enabling an actuated displacement and a compliant displacement, and wherein the device is configured for taking an intervening action when a compliant displacement exceeds a first threshold, which first threshold is a non-constant function of the actuated displacement.

### BRIEF DESCRIPTION OF THE DRAWINGS

FIG. 1a is an illustration device (1) according to the present disclosure. FIG. 1b is a side view of a device according to an embodiment of the invention. FIG. 1c is a perspective elevated view of a device according to an embodiment of the invention. FIG. 1d is a perspective bottom view of a device according to an embodiment of the invention.

FIGS. 2-9 are side views of an actuated device (1) illustrating several displacements, positions and thresholds in accordance with the invention.

FIG. 10-13a depict the relation between the thresholds for the triggering of an intervening action and the actuated displacement/position of the non stationary member.

### DETAILED DESCRIPTION OF THE INVENTION

In order to avoid any injury to a human as well as damage to objects and the infrastructure of the robot itself, it is desirable to provide a device, such as an actuated device and method for the autonomous charging of electric vehicles with systems that promptly and adequately respond to a force or a pressure generated by the disruptions that can take place during the overall charging process or its preceding or subsequent steps.

The invention thereto proposes a device for connecting a connector of an electric vehicle charger to a socket of an electric vehicle, comprising: a stationary member that forms part of a fixed world and/or the vehicle charger and/or an actuated mechanism; a non-stationary member for carrying a connector that is displaceable with respect to the stationary member along respective lines substantially parallel to each other by means of both: an actuated displacement from a default position to an actuated position; and a superimposed compliant displacement from the actuated position to an actual position; at least one controllable actuator for accomplishing the actuated displacement; a compliance assembly for accomplishing the compliant displacement; a controller assembly, for: controlling the controllable actuator; determining the actual position; and/or determining the compliant displacement of the non-stationary member; wherein the controller assembly is further configured for taking an intervening action when the compliant displacement exceeds a first threshold; which first threshold is a non-constant function of the actuated position.

The invention further describes a method for operating a device for connecting a connector of an electric vehicle charger to a socket of an electric vehicle, the device comprising: a stationary member that forms part of a fixed world and/or the vehicle charger and/or an actuated mechanism; a non-stationary member: for carrying a connector; that is displaceable with respect to the stationary member along respective lines substantially parallel to each other by means of both: an actuated displacement from a default position to an actuated position; and a superimposed compliant displacement from the actuated position to an actual position; at least one controllable actuator for accomplishing the actuated displacement; a compliance assembly for accomplishing the compliant displacement; the method comprising the steps of: controlling the controllable actuator; determining the actual position; and determining the compliant displacement of the non-stationary member; characterized by taking an intervening action when the compliant displacement exceeds a first threshold; which first threshold is a non-constant function of the actuated position.

The device according to the invention may also be referred to as an actuated device for connecting a connector of an electric vehicle charger to a socket of an electric vehicle. It may also, in the context of the invention, be referred to as an “electric vehicle charging robot”, or simply a “robot”. An actual vehicle charger may be coupled to the connector by means of a cable and may be incorporated in or coupled or connected to a device according to the invention.

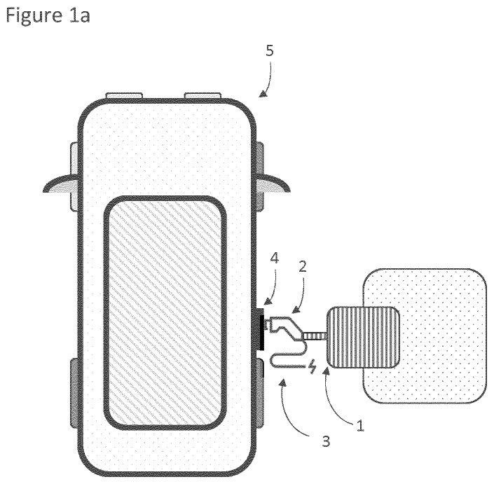

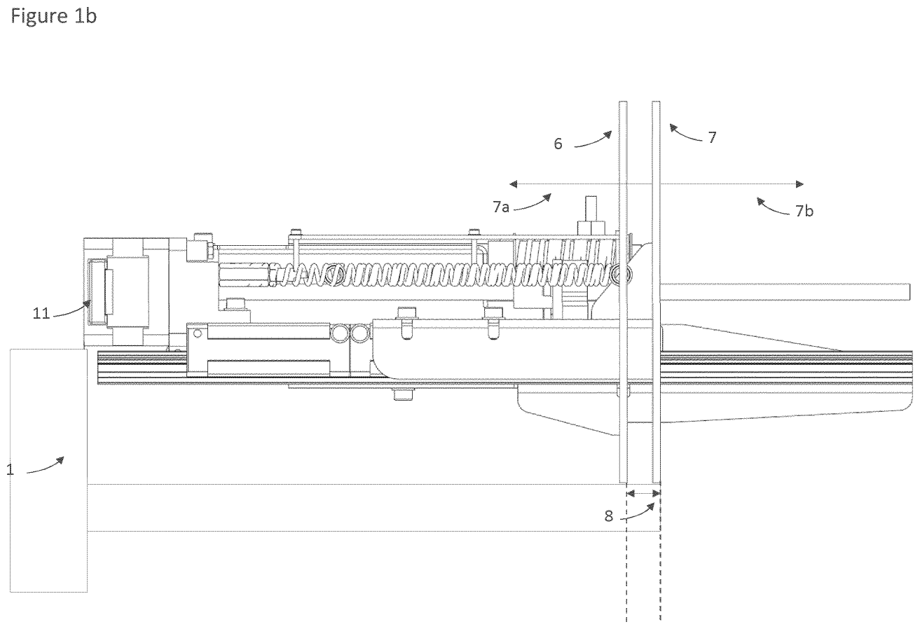

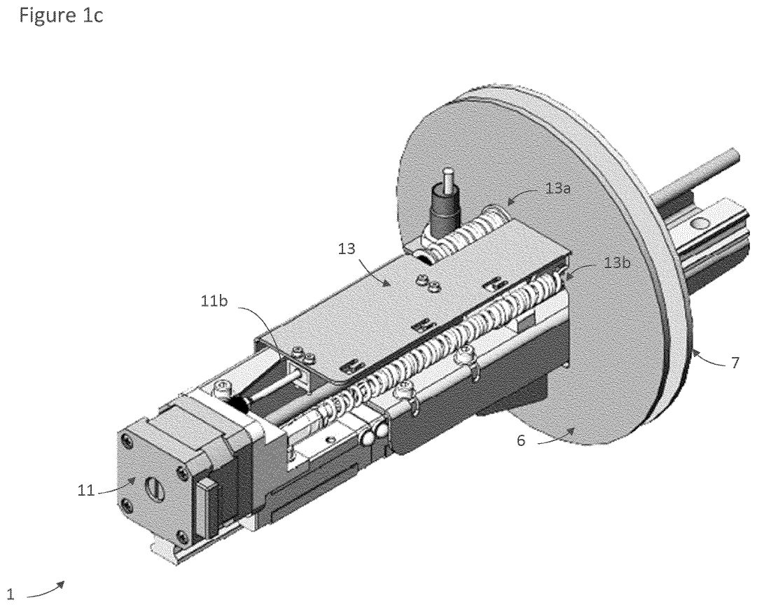

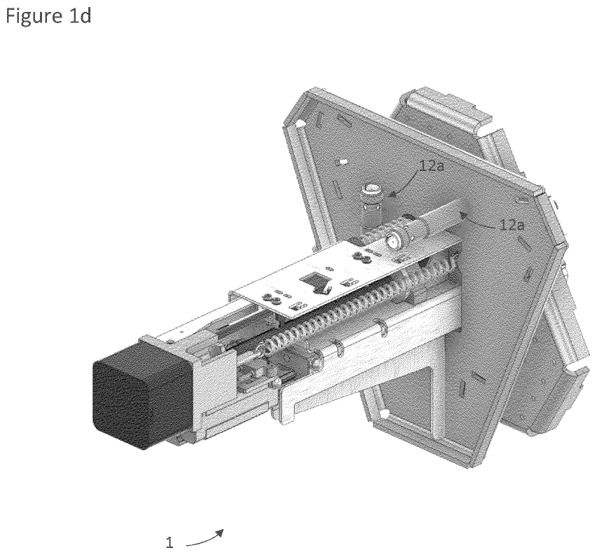

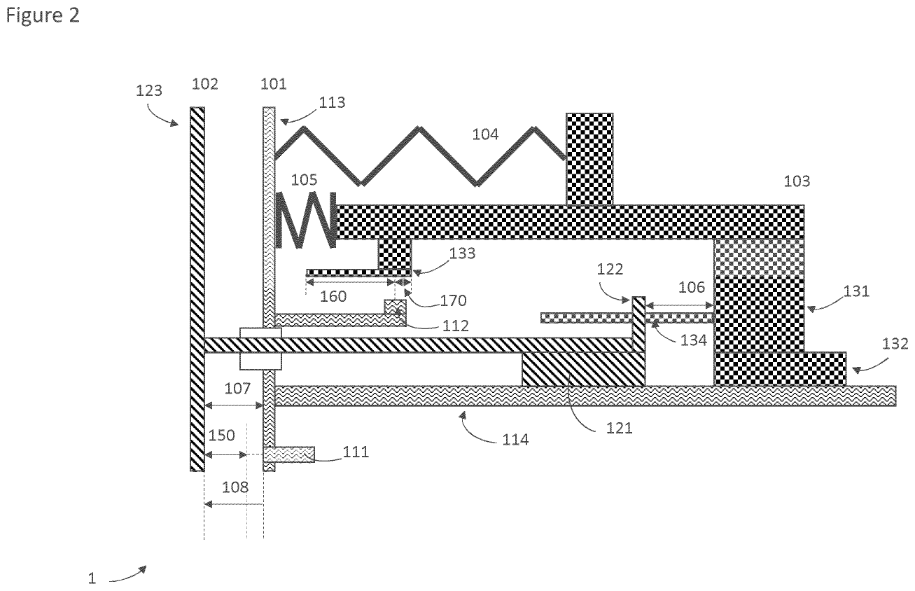

FIG. 1a shows an illustration of a device (1) according to the present disclosure, including a connector (2) of an electric vehicle charger (3), a socket (4) of a vehicle, and a vehicle (5). FIGS. 1b and 1c are perspective views of a device according to an embodiment, and FIG. 2 is an illustration of the said embodiment.

The device comprises a stationary member (6) that forms part of a fixed world, the electric vehicle charger and/or an actuated mechanism. The stationary member (6) is the member that during normal use does not move with respect to its support or the fixed world around the device. The support may be interpreted as an actuated mechanism with at least one degree of freedom, or at least two degrees of freedom or at least three degrees of freedom, such as one, two or three degrees of linear freedom. The stationary member can include a base plate, at least one engagement point for coupling a compliance assembly or an element or component thereof. The stationary member may also include a fixing point for the controller assembly (12) or for any component thereof. The stationary member (6) may also include a linear rail for enabling the displacement of the non stationary member (7) along a path.

The actuated device comprises a non-stationary member (7) for carrying a connector for charging an electric vehicle and is primarily non-stationary relative to the stationary member and therefore effectively also non-stationary relative to the rest of the actuated mechanism, i.e. to the robot, to an environment or support, and/or to said fixed world. The non-stationary member is displaceable with respect to the stationary member (6) along respective lines substantially parallel to each other by means of both an actuated displacement by the at least one controllable actuator; and a compliant or superimposed compliant displacement e.g., by an external force. In more detail, the non-stationary member (7) is displaceable with respect to the stationary member (6) by two means along respective lines substantially parallel to each other by means of both: an actuated displacement facilitated by the at least one controllable actuator from a default position (8) to an actuated position; and a superimposed compliant displacement from the actuated position to an actual position. In particular, the substantially parallel lines are substantially in the direction of mating of the connector, if the connector is attached to the actuated device or where the connector is intended to be attached to. The non-stationary member can include a base section an effector plate and a spindle nut. The base section is preferably fixed to the effector plate at a longitudinal position and the effector plate can be configured to provide support the connection of an electric vehicle charger and base. The non-stationary member (7) can also provide support for the connection of an electric vehicle charger. The non-stationary member (7) can be configured to permanently hold the connector and/or configured to engage and disengage the connector.

The latter is particularly useful when the actuated device, or the fixed world and/or the vehicle charger and/or an actuated mechanism that is forms part of, is configured to connect and/or disconnect several connectors to/from different sockets.

The actuated device comprises at least one controllable actuator (11). In this context, an actuated displacement is defined as displacement with the aid of said at least one controllable actuator, wherein the actuator (11) herein refers to an element capable of providing a driving force, preferably to the non-stationary member (7). Examples of a controllable actuator may include a motor, a stepper motor, a linear motor, an electronic motor, a DC motor, an AC motor, a linear actuator, an electric actuator, and the like, but are not limited thereto. As used herein, the term “controllable” is used here to connote that the actuator is configured for receiving a signal and based on that signal, providing a driving force. Preferably, the controllable actuator (11) further comprises an actuator body (11a) and/or a spindle (11b) which can be supported by a spindle nut.

Compliant displacement is defined as a displacement generally caused by the exertion of a force preferably on the non-stationary member, or on an element mechanically or compliantly connected to it, substantially in the direction as allowed by the compliance assembly (13). The force may be exerted by humans or objects, which may have a fixed position or that may move. The force may also be exerted by a component of the device itself, or objects that are a component of the actuated mechanism, the fixed world or the like. Compliant displacement may also be caused by the vehicle moving when the connector is already in the socket. Such movement can occur due to the vehicle not standing still, or people or objects entering or leaving the vehicle. Inertial forces working on the non-stationary member by acceleration/deceleration of the motor or the mechanical device may in practice also result in a compliant displacement. However, these inertial forces are considered irrelevant to this invention.

The actuated device (1) further comprises a compliance assembly (13) for accomplishing, enabling and/or facilitating the compliant displacement. The compliance assembly comprises at least one and more preferably at least two resilient or compliance elements, which are referred to herein as any element that can provide for a compliant response. Compliance elements may have a functionally relevant stiffness, damping or a combination thereof. In particular, typical components that have a relevant stiffness and/or damping are springs (coil spring, leaf spring etc.), dampers, gas springs, valves (for pneumatic/hydraulic damping), etc.

The non-stationary member (7) is able to be displaced with respect to the stationary member.

Preferably, the non-stationary member is able to be displaced in an actuated displacement and/or in a compliant displacement along respective lines substantially parallel to each other (e.g., lines 7a, 7b). The non-stationary member (7) is preferably able to be displaced in two directions, substantially opposite to each other, with respect to the stationary member (6), and therewith to any element mechanically connected to the stationary member (6). The non-stationary member (7) can be mechanically coupled to the actuator (11) by a non-compliant and/or by a compliant element. The actuator can be mechanically coupled to the non-stationary member and can displace said non-stationary member in an actuated displacement via a mechanical means, such as a spindle (11b), for example, when the actuator is activated and exerts a force on said non-stationary member. The controllable actuator (11) is preferably compliantly coupled to the stationary member by a compliant element, and can be therefore compliantly displaced by a force exerted on the non-stationary member to which the actuator (11) is preferably mechanically (non compliantly) coupled. The stationary member (7) can be compliantly coupled to the non-stationary member by a compliant element that allows a compliant motion in at least one degree of freedom. The compliance assembly (13) can comprise at least one, or at least two, or at least three compliance elements.

The compliance assembly (13) can facilitate the actuated device in self-seeking the socket of an electric vehicle, softening the impact between the connector and the socket as well as allowing the connector to move along with the vehicle within certain boundaries once connected to the socket. The compliance assembly (13) can have a certain range of stiffnesses and to this end, can include at least one compliance element having an elastic force.

A first compliance element preferably compliantly couples the stationary member (6) to the actuator (11), to the actuator body (11a), or to a connecting point thereof, and provides the actuator (11) with a compliant displacement in one degree of freedom, for example when an external force is exerted on the non stationary member (7) which compliantly displaces the actuator (11). The first compliance element is preferably selected from a compression compliance element. A second compliance element compliantly couples the stationary member (6) to the actuator (11), to the actuator body (11a), or to a connecting point thereof, and provides the actuator (11) with a compliant displacement in one degree of freedom for example when an external force is exerted on the non stationary member (7) which compliantly displaces the actuator (11). The second compliance element is preferably selected from an extension compliance element. The types of the first and second compliance elements, i.e., either an extension, compression or other compliance type are not mutually exclusive and may be interchangeable.

The non-stationary member (7) is able to be compliantly displaced by the exertion of an external force or “load event” applied on the actuated device (1) or on any element mechanically connected to it, for example, on the connector for the charging of an EV. The terms “external force” or “load event” are to be interpreted as a force exerted on the non-stationary member or on any element mechanically connected to it that triggers a compliant response from the compliance assembly. Examples include a force, such as a pushing force, exerted by humans or objects along the path of the movement actuated device, as well as the force exerted by passengers getting on or off the vehicle, the loading and unloading of luggage, external shocks on the vehicle, vibrations, and combinations thereof. The external force on the actuated device or on any element mechanically connected to it refers mainly to an external force applied over an axis substantially parallel to the imaginary axis, in two directions substantially opposite to each other, for example, when a pulling force is exerted on the actuated device.

The non-stationary member (7) is able to be displaced with respect to the stationary member.

Preferably, the non-stationary member is able to displaced in an actuated displacement and/or in a compliant displacement along respective lines substantially parallel to each other. Thus, the non-stationary member can be subject to a different displacement which may bring it to a different position than the actuated position. In the context of the invention, the term displacement is intended to mean the movement or displacement of a body, for example, the non-stationary member along a path, such as a linear rail (6d).

In accordance with the invention, a default position (8) of the non-stationary member (7) is a position where no external forces nor actuated displacement is being applied onto it. The position where the non-stationary member (7) is relative to the stationary member under influence of the actuated displacement if there isn't (or wouldn't be) an external force effectuating a compliant displacement is referred to as the actuated position. The position of the non-stationary member relative to the stationary member when the effect of an external force resulting in a compliant displacement is accounted for is defined as the actual position.

Consequently, the actual position may be the result of a compliant displacement superimposed to an actuated displacement that can be zero or greater than zero. In certain cases, the actual position may be the result of a compliant displacement superimposed to an actuated displacement that is lower than zero.

The actuated device (1) comprises a controller assembly (12) for controlling the controllable actuator; determining the actual position of the non-stationary member; and/or determining the compliant displacement of the non-stationary member.

The controller assembly is further configured for taking an intervening action when the compliant displacement exceeds a first threshold, which first threshold is a non-constant function of the actuated position.

The controller assembly (12) can be configured for controlling the controllable actuator; determining the actual position; and/or determining the compliant displacement of the non-stationary member.

The term “assembly” as used herein is a broad term and is to be given its ordinary and customary meaning to a person of ordinary skill in the art and is not to be limited to a special or customized meaning. Preferably, the term “assembly” encompasses a set of elements that are grouped under an underlying functionality and which can be in fluid communication with each other, such as via an electric signal. Elements part of an assembly as used herein may be not necessarily mechanically coupled with each other.

The term “determining” (and grammatical variants thereof) encompasses a wide variety of actions and as used herein is a broad term and is to be given its ordinary and customary meaning to a person of ordinary skill in the art and is not to be limited to a special or customized meaning.

As used herein, the term “determining the actual position” specifically may refer, without limitation but preferably to sensing, detecting, monitoring, measuring, estimating and/or calculating the actual position of the non-stationary member (7) and/or the force that is applied onto it.

As used herein, the term “determining the compliant displacement” specifically may refer, without limitation but preferably to sensing, detecting, monitoring, measuring, estimating and/or calculating the actual position (7) and/or the force that is applied onto it.

Preferably, the determination of the actual position and/or the compliant displacement is made through at least a sensor. To this end, the controller assembly (12) can include one or more sensors (12a) selected from a safety sensor, a distance sensor, a proximity sensor, a positioning sensor, a magnetic sensor, a force sensor or a combination thereof. For example, in order to determine the compliant displacement, the controller assembly (12) may comprise a first sensor, such as a proximity sensor. A proximity sensor in accordance with the present disclosure can sense if an object is within the sensing area where the sensor is designed to operate. The proximity sensor can be configured to determine the proximity and provide an output, such as a binary output. Additionally, the sensor may provide a position output to determine distance. Furthermore, given that force can be used as a measure of a compliant displacement, the determination of the compliant displacement can be made through the determination of the force that is applied onto the non-stationary member (7) via different mechanisms, but preferably through the use of a force sensor. The first sensor (12a) can be configured to determine when the non-stationary member is in a determined position in the proximity of the sensor and change an output value when the measured object, i.e., the non-stationary member is at a certain position or proximity. The first sensor may be alternatively or additionally configured to determine a distance between the sensor and the non-stationary member (7), on a continuous basis or non-continuous basis, and change an output value when the measured object, i.e., the non-stationary member is at a certain distance from the distance sensor. More than one sensor may be used in accordance with the principles of the invention. The controller assembly (12) may also be able to determine the actual position of the non-stationary member (7), and determining the compliant displacement by comparing the actual position with the actuated position. The controlling assembly can be further configured for determining the compliant displacement from a measured force exerted on the non-stationary member. Furthermore, the sensor array can include two sensors, wherein the first sensor is configured for providing a signal or data that represents the actual position and/or determines proximity of the non-stationary member, and wherein the second sensor is configured for providing a signal or data that represents the compliant displacement of the non-stationary member or a force exerted on the non-stationary member in a direction substantially along the direction of the compliant displacement

The controller assembly can comprise a controller that is configured to receive an incoming signal and to send an outgoing signal, preferably an electrical signal. An incoming signal can be the output of a sensor and an outgoing signal can be a signal sent to the controllable actuator. Preferably, an outgoing signal can be an intervening action in accordance with the definitions of the present invention. The controller, which is part of the controller assembly can be any means which based on a signal received by a sensor is configured to send an intervening action. The controller may be selected from a safety relay.

The controller assembly may in a simple form comprise a sensor and/or a switch for providing a signal and a switch or (safety) relay for responding on the signal. More sophisticated embodiments may comprise the use of data from a force sensor. The system can comprise rather simple and therefore robust mechanical or elect(on)ic components, but a microprocessor is not excluded.

Preferably, the determination of the actual position and/or the compliant displacement is made through at least a sensor.

The controller assembly can be further configured for controlling the actuated displacement based on a determined or an estimated position of the socket on an electric vehicle and in particular for controlling the actuated displacement for moving a connector to or from such a socket of an electric vehicle. The actuated displacement can be controlled by sending a control signal to a dedicated controller for controlling the actuated displacement.

The controller assembly can be configured for taking an intervening action. The actuated device of the invention is prone to disruptions, so it is desirable that the device is able to promptly react to disruptions that may harm the robot itself, harm its operators and/or people around it, or damage the vehicle it's trying to connect the connector, or damage objects surrounding the robot.

An intervening action may include the sending of an outgoing signal, such as an electric signal to the controllable actuator. In more detail, an intervening action may include an interruption of the movement of the actuated device, such as during a positioning, plug in or connecting stage; a new attempt to complete the plug in process and/or a re-positioning of the actuated device relative to the socket of the electric vehicle. Preferably, an intervening action includes the interruption of the connecting process by interrupting or stopping the actuated displacement of the non-stationary member that carries the connector.

Furthermore, the intervening action can be dependent on the actuated displacement of non-stationary member. The actuated displacement may be zero, greater than zero or lower than zero and the intervening action may be adapted accordingly. The intervening action may include any of: changing the actuated displacement or actuated position of the non-stationary member; interrupting or stopping the actuated displacement or actuated position of the non-stationary member; changing the speed or direction of the actuated displacement or actuated position of the non-stationary member; moving the non-stationary member to(ward) a predetermined position; changing the mode of control of the actuator, in particular changing the controller setting to control the force exerted by the actuator, more in particular changing the controller setting to control to follow haptic input (f.e. zero force control, damping control, etc.), in general changing the mode of control of the actuator to allow a back driven motion (f.e. a user pushing back the connector, and the actuated displacement following the direction of the exerted force); cutting the power from the actuator; and any combinations of the above.

The controller assembly (12), and in particular the controller, can be configured to receive a signal from the at least one sensor and to send a signal, preferably, a signal for an intervening action when the compliant displacement exceeds a first threshold, which first threshold is a non-constant function of the actuated position. By taking an intervening action, the device according to the invention provides an increased safety and it thus takes away the disadvantages associated with the prior art. The range of allowable compliance displacement is a non-constant function of the actuated displacement, whereby the controller can trigger an intervening action when the compliant displacement exceeds the threshold that is tolerated at the actuated displacement where the non-stationary member is currently at.

In more detail, an intervening action can be triggered when the compliant displacement exceeds a first threshold, which first threshold is a non-constant function of the actuated position. In a non-limiting exemplary embodiment, function 1 (f1), function 2 (f2), function 3 (f3) and function 4 (f4) can be threshold functions. These functions may be constant, linearly increasing or decreasing, exponentially increasing or decreasing, logarithmically increasing or decreasing, either smooth or not, or any another continuous function. The functions can depend on the actuated position, the actuated displacement, or their respective derivatives.

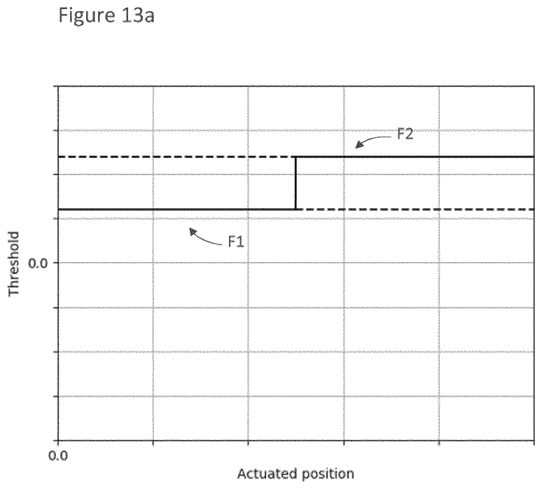

In accordance with the invention, function 1 (f1), function 2 (f2), or a combination thereof can represent a threshold for pushing forces (100) applied over the non-stationary member. Function 3 (f3), function 4 (f4), or a combination thereof can represent a threshold for pulling forces (130). The functions may be combined, whereby for function 1 and function 2 a discontinuous function of the type can be observed.

$$f ( a , b ) = \{ \begin{matrix}{f}_{1} ( a , b ) , & y \leq z \\ {f}_{2} ( a , b ) , & y > z\end{matrix}$$

where y may be actuated position, compliant displacement or force, and z is a designed value. In a preferred embodiment, the combined function comprises an increasing or decreasing function and a constant. In a more preferred embodiment, the combined function of function 1 and function 2 comprises a function linearly increasing with actuated position, which is maximized by a constant function from a certain value of actuated position. The actuated displacement is generally positive but can be at cases a negative actuated displacement, i.e., whereby the actuator is retracted further back from the default position as depicted by FIG. 13b. In accordance with the invention, the first threshold is a threshold in a first direction of the compliant displacement from the actuated position, wherein the controller is further configured for taking an intervening action when the compliant displacement exceeds a second threshold, wherein the second threshold is a threshold in a second direction, opposite to the first direction, wherein the value of the first and the second threshold differ from each other. I.e. the first threshold pertains to pushing forces or a positive compliant displacement, and the second threshold pertains to pulling forces or a negative compliant displacement. The first and/or second threshold can be a function of a momentary speed at which the actuated and/or compliant displacement takes place.

The functions may be considered as a threshold on force, but may be implemented by either measuring force, by measuring compliant displacement, or a combination thereof.

In accordance with the invention, different stages may be defined when describing the process for the autonomous charging of an electric vehicle. A process can include at least a positioning phase, a connecting phase, a charging phase and a disconnecting phase. Furthermore, depending on the operation of the actuated device (1), further stages may be established, namely, a neutral stage and an active stage wherein said stages are not mutually exclusive with positioning, connecting, charging and disconnecting phases. A neutral stage can refer to the stage wherein the actuator does not exert an actuated displacement of the non-stationary member. As a non-limiting example, a neutral stage is the stage where the robot is positioning the connector in the proximity of the socket but is not yet expected to exert a significant force to complete the connection. At the neutral stage the actuated displacement of the non-stationary member is generally low or preferably zero, since the actuated device may be positioned in proximity of the socket by additional actuated mechanisms. An active stage refers to the stage wherein the controllable actuator (11) exerts a displacement of the non-stationary member. As a non-limiting example, an active stage is the stage where the actuated device (1) has positioned the connector in the close proximity of the socket of the EV and is expected to exert a greater force to complete the connection. At the active stage, the actuated displacement is preferably greater than zero.

FIGS. 1b and 1c schematically show a device (1) for connecting a connector (2) of an electric vehicle charger (3) to a socket (4) of an electric vehicle EV (5), comprising a stationary member (6) that forms part of a fixed world and/or the vehicle charger and/or an actuated mechanism, a non-stationary member (7) for carrying a connector that is displaceable with respect to the stationary member along respective lines substantially parallel to each other by means of both: an actuated displacement from a default position (8) to an actuated position; and a superimposed compliant displacement from the actuated position (8) to an actual position; at least one controllable actuator (11) for accomplishing the actuated displacement; a compliance assembly (12) for accomplishing the compliant displacement; and a controller assembly. FIG. 1b is a representation of a default position of the non-stationary member (7).

FIG. 1c schematically shows an elevated perspective view of the device (1) and two compliance elements (13a) and (13b). The stationary member (6) is compliantly coupled to the controllable actuator (11) or to its body (11a) through a first compliance element (13a); a second compliance element 13b compliantly couples the stationary member 6 to the controllable actuator (11) or to its body (11a). In this representation, the first and second compliance elements are a compression and an extension element, respectively. FIG. 1b shows that the controllable actuator (11) is mechanically coupled to the non-stationary member (7) via a spindle (11b) to accomplish an actuated displacement.

FIG. 2 shows an embodiment of the invention where the stationary member (101) comprises a front plate (113). A linear rail (114), a sensor (111) to monitor the actual position (107), a sensor (112) to monitor the compliant displacement (109) as part of the controlling assembly, are also shown.

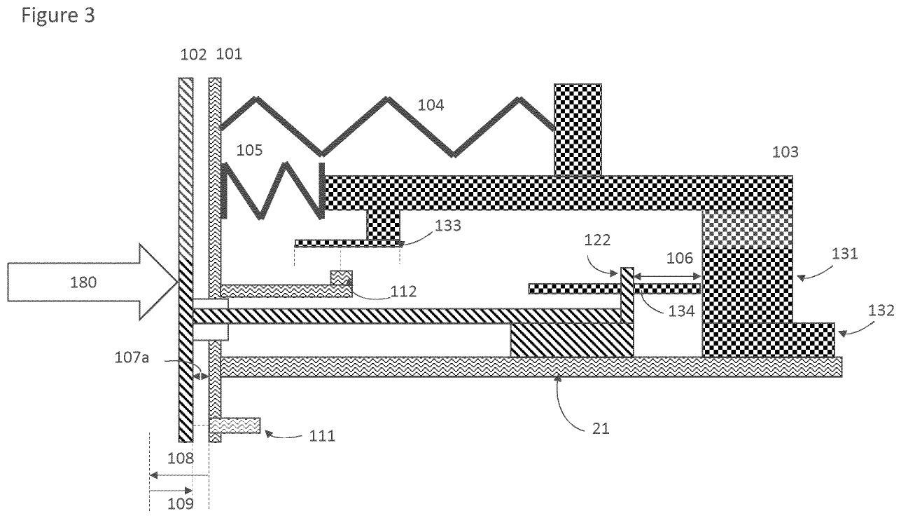

FIG. 2 shows the non-stationary member (102) which comprises an effector plate (123) through which a connector of an electric vehicle may be connected. A linear guide (121), a spindle nut (122) are also shown, wherein the non-stationary member (102) moves along said linear rail (114). A controllable actuator, also referred to herein as an actuator assembly (103) including an actuator (131), a linear guide (132), a sensor plate (133) for being monitored by sensor (112) and a spindle (134) are also shown. In this embodiment, the actuator (103) includes is a stepper motor (131) with a spindle (134) that drives the spindle nut (122). Other embodiments may make use of other actuators. The actuator (131) can effectuate an actuated displacement (106), which may be considered as the distance between the spindle nut (122) and the actuator (131). Consequently, this results in the non-stationary member (102) being displaced. The position where the effector plate (123) is relative to the front plate (113) of the stationary member (101) under influence of the actuated displacement (106) if there is no (or wouldn't be) an external force effectuating a compliant displacement (109) is defined as the actuated position (108, shown in FIG. 3). Subsequently, the position of the effector plate (123) relative to the front plate (113) of the stationary member (101) when the effect of an external force resulting in a compliant displacement (109) is accounted for is defined as the actual position (107).

In addition, FIG. 2 shows an extension spring (104) as a second compliance element with a substantially constant stiffness, and a compression spring (105) as a first compliance element with a substantially constant stiffness as part of the compliance assembly. Both springs can be mounted with a certain pretension, such that they remain under load over a range of allowable compliant displacement.

FIG. 3 shows the effect of a compliant displacement (109) by an external force (180) at the default position. The controller assembly, and in particular the sensor (111) that monitors the actual position (107a), which, based on a threshold function 1, triggers said sensor (111). The sensor (112), which monitors compliant displacement provides a constant value for threshold function 2 (160) on the compliant displacement due to pushing force (and therewith a threshold on pushing force) and a constant value for threshold function 3 (170) on pulling force (and therewith a threshold on pulling force). The sensor (112) that monitors compliant displacement (109) measures the proximity of the sensor plate (133). When the sensor plate (133) is not directly above the sensor (112), the sensor switches its output value. In FIG. 3 the sensor plate (133) monitored by sensor (112) is positioned in front of it, so no output value is changed and no action is triggered, such as an intervening action.

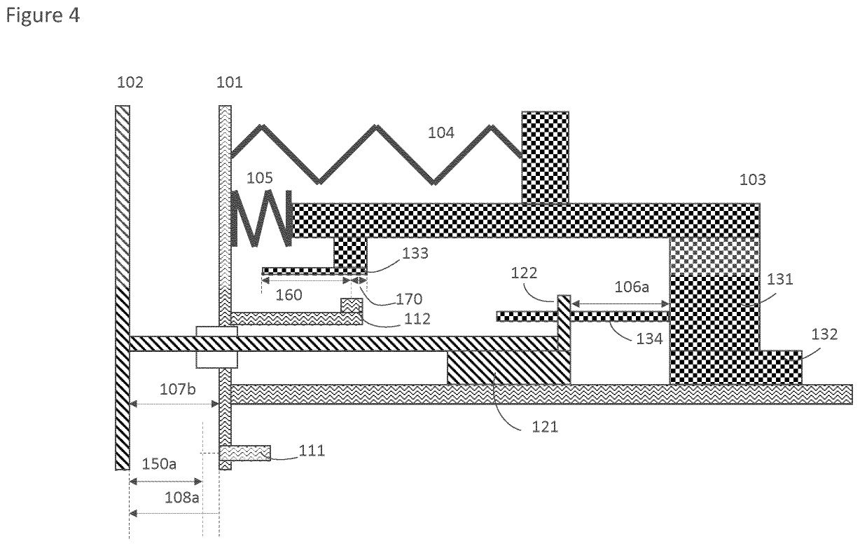

FIG. 4 shows at the actuated displacement (106a), the actual position (107b), the actuated position (108a). The actuated position (108a) defines an increased value of threshold of function 1 (150a) compared to the threshold value (150) at actuated displacement (106). The sensor plate (133) monitored by sensor (112) is positioned in front of it, so no output value is changed and no action is triggered, such as an intervening action.

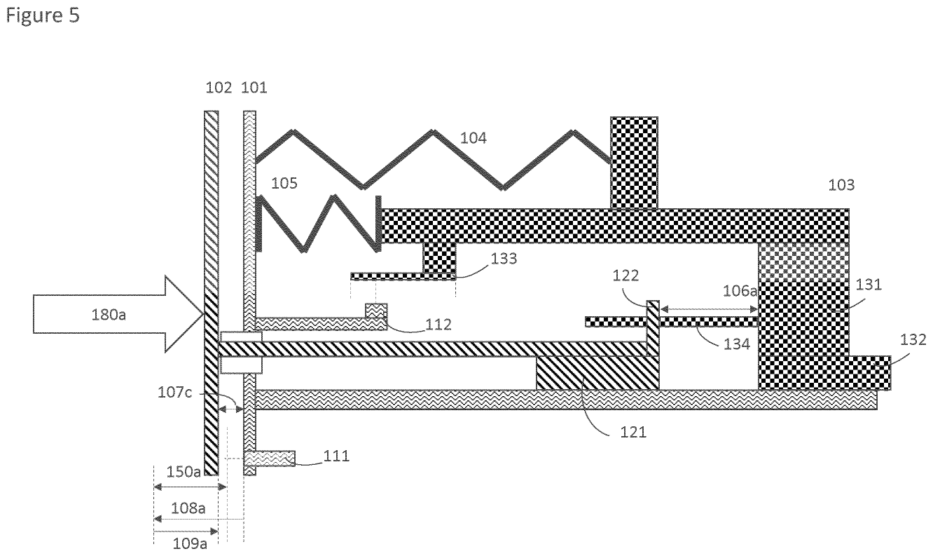

FIG. 5 shows the effect of an external force (180a) at a threshold value of function 1 at the actual position (107c). The sensor (111) monitors the actual position, which provides a threshold (150a) on compliant displacement (109a) based on a pushing force (and therewith a threshold on pushing force) that linearly increases with the actuated displacement (106a). The external force (180a) results in a compliant displacement (109a) of the non-stationary member, being the displacement not greater than the threshold (150a) and sensor (111) does not change its output signal.

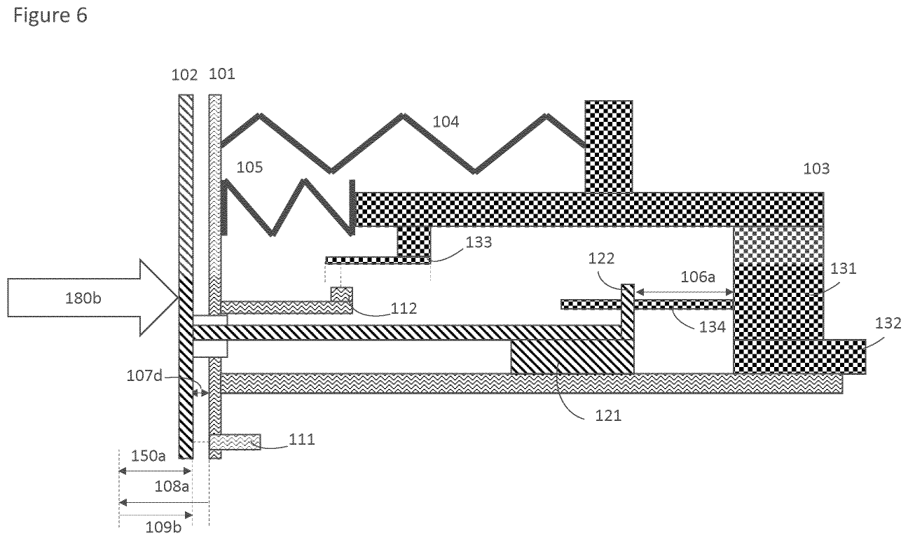

FIG. 6 shows the effect of an external force (180b) at the threshold value of function 1 (150a) at an actuated position (108a). The sensor (111) monitors the actual position (107d), which provides a threshold (150a) for the compliant displacement (109b). The external force(180b) triggers the sensor (111), which monitors whether actual position (107d) crosses the threshold value of function 1 (150a).

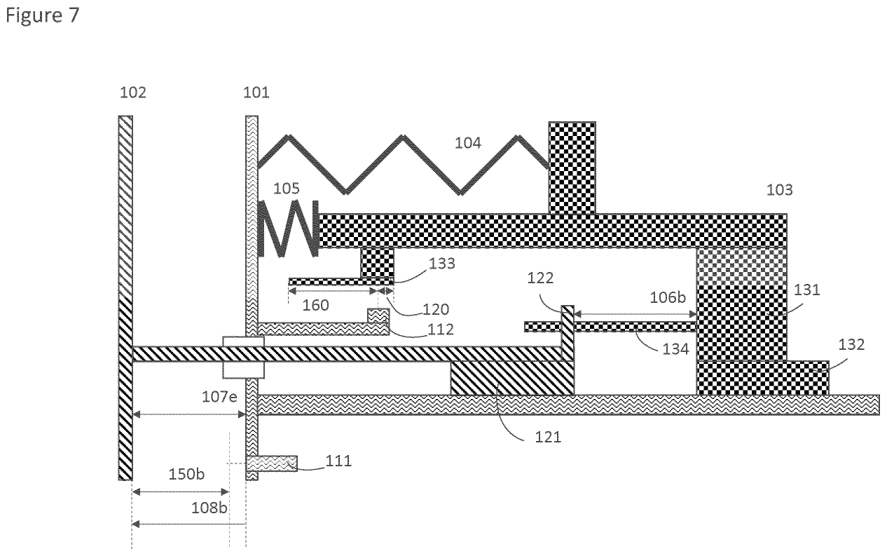

FIG. 7 shows the actuated device (1) when an actuated displacement (106b) takes place, which leads to an actuated position (108b) of the non-stationary member. Given that the actuated displacement (106b) has increased the actuated position (108b), and that the actual position (107e) is equal to the actuated position (108b) due to no external forces are being applied, the value of threshold function 1 (150b) has increased through changing the actuated position (108b). The value of threshold function 2 (160) remains the same and the value of the threshold of function 1 (150b) is now larger than the value of function 2 (160).

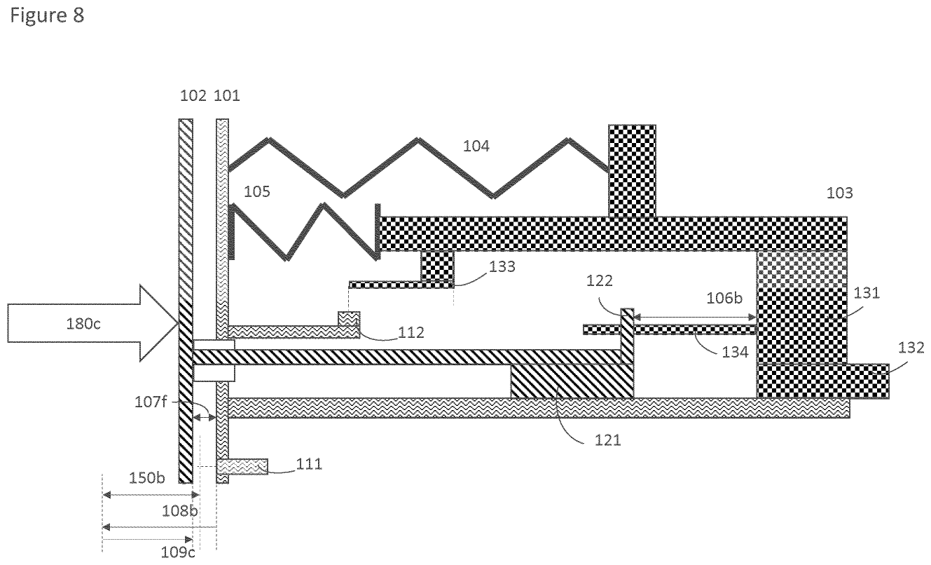

FIG. 8 shows the effect of an external force (180c) at the threshold value of function 2 (160) at an actuated position (108b) and upon exertion of force (180c) that leads to a compliant displacement (109c). The sensor (111) monitors the actual position (107f) provides a threshold (150b) for the compliant displacement (109c). The external force (180c) causes the sensor plate (133) to not be in front of sensor (112), which monitors the function 2, causing sensor (112) to change its output value.

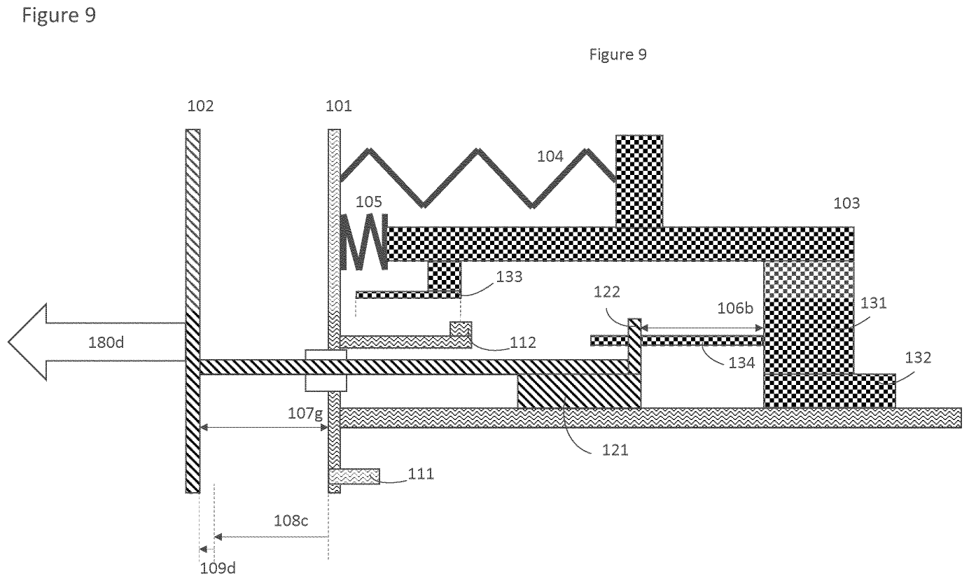

FIG. 9 shows the effect of an external force (180d), and in particular, a pulling force. External force (180d) leads to a compliant displacement (109d) and an actual position (107g). The external force (180d) causes the sensor plate (133) to not be in front of sensor (112), which monitors the function 3, causing sensor (112) to change its output value.

The relation between the thresholds on compliant displacement (150, 150a, 150b) and their respective threshold forces can be dependent (amongst others) on the choice of compliant components. In one embodiment, the compliant elements exert a force based on their deflection such as extension springs, compression springs, or a combination. Their stiffness may be constant, but may also very with deflection. Other embodiments may include compliant components that provide damping.

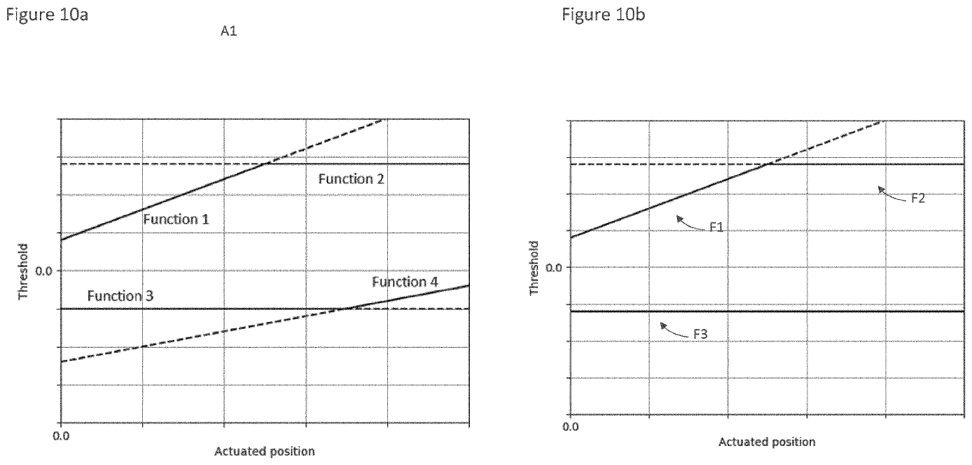

FIG. 10a shows a chart representing the relation between the thresholds and four different functions (Function 1, Function 2, Function 3, Function 4). The combined function of function 1, function 2 depicts of a function linearly increasing with actuated position, which is maximized by a constant function from a certain value of actuated position. The combined function of function 3, function 4 depicts of a constant function which linearly increases with the actuated position from a certain value of actuated position.

FIG. 10b shows a chart representing the relation between the threshold and three different functions (Function 1, Function 2, Function 3). The combined function of function 1, function 2 depicts of a function linearly increasing with actuated position, which is maximized by a constant function from a certain value of actuated position. Function 3 is constant function, i.e, the threshold does not change depending on the actuated position.

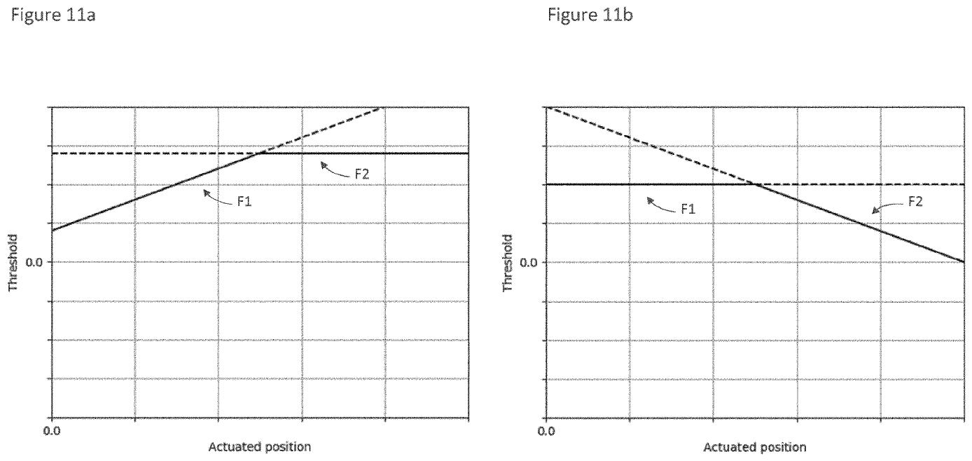

FIG. 11a shows a chart representing the relation between the threshold and two different functions (Function 1, Function 2). The combined function of function 1, function 2 depicts of a function linearly increasing with actuated position, which is maximized by a constant function from a certain value of actuated position.

FIG. 11b shows a chart representing the relation between the threshold and two different functions (Function 1, Function 2). The combined function of function 1, function 2 is a constant function which linearly decreases with the actuated position from a certain value of actuated position.

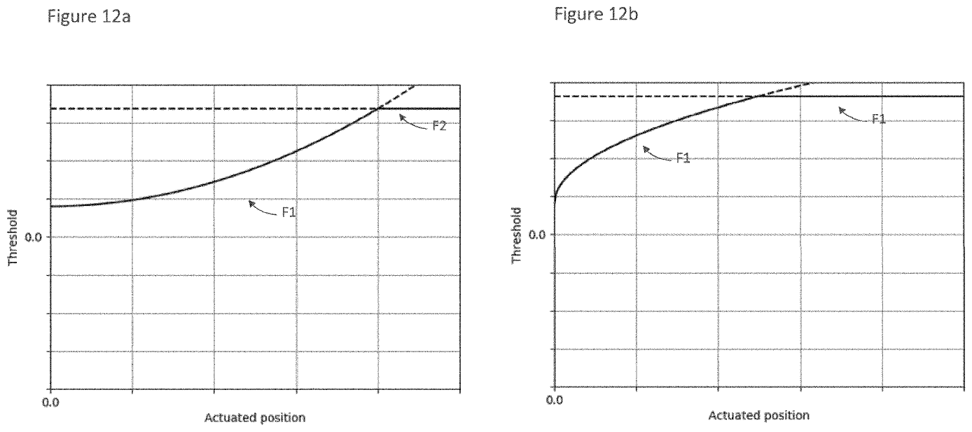

FIG. 12a shows a chart representing the relation between the threshold and two different functions (Function 1, Function 2). The combined function of function 1, function 2 depicts of a function exponentially increasing with actuated position, which is maximized by a constant function from a certain value of actuated position.

FIG. 12b shows a chart representing the relation between the threshold and two different functions (Function 1, Function 2). The combined function of function 1, function 2 depicts an increasing logarithmic function with actuated position, which is maximized by a constant function from a certain value of actuated position.

FIG. 13a shows a chart representing the relation between the threshold and two different functions (Function 1, Function 2). The combined function of function 1, function 2 depicts a constant function with a step increase from a certain value of actuated position.

The position or proximity sensors may include those that use inductive, capacitive, laser distance, potentiometer or other technologies. Sensors in other embodiments may include force-based sensors that use strain gauge, inductive, capacitive piezoelectric or other technologies.

While the invention has been described in connection with what is presently considered to be the most practical and preferred embodiment, it is to be understood that the invention is not to be limited to the disclosed embodiment(s), but on the contrary, is intended to covervarious modifications and equivalent arrangements included within the spirit and scope of the appended claims, which scope is to be accorded the broadest interpretation so as to encompass all such modifications and equivalent structures as permitted under the law.

Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim.

1. Device for connecting a connector of an electric vehicle charger to a socket of an electric vehicle, comprising:
a stationary member that forms part of a fixed world and/or the vehicle charger and/or an actuated mechanism;
a non-stationary member for carrying the connector, that is displaceable with respect to the stationary member along respective lines substantially parallel to each other by means of both:
i. an actuated displacement from a default position to an actuated position; and
ii. a superimposed compliant displacement from the actuated position to an actual position;
at least one controllable actuator for accomplishing the actuated displacement;
a compliance assembly for accomplishing the compliant displacement;
a controller assembly, for
controlling the controllable actuator;
determining the actual position; and
determining the compliant displacement of the non-stationary member;
characterized in that
the controller assembly is further configured for taking an intervening action when the compliant displacement exceeds a first threshold, wherein the first threshold is a non-constant function of the actuated position.

2. Device according to claim 1, wherein the intervening action is dependent on the actuated displacement.

3. Device according to claim 1, wherein the intervening action comprises at least one of:
changing the actuated displacement or actuated position of the non-stationary member;
stopping the actuated displacement or actuated position of the non-stationary member;
interrupting the actuated displacement or actuated position of the non-stationary member;
changing the speed or direction of the actuated displacement of the non-stationary member;
displacing the non-stationary member to(ward) a predetermined position;
changing the mode of control of the actuator, including changing the controller setting to control the force exerted by the actuator and/or to allow a back driven motion;
cutting the power from the actuator; and
any combination of the above.

4. Device according to claim 1, wherein the controller assembly is further configured for determining the compliant displacement by comparing the actual position with the actuated position.

5. Device according to claim 1, wherein the controller assembly is further configured for determining the compliant displacement from a measured force exerted on the non-stationary member.

6. (canceled)

7. (canceled)

8. Device according to claim 1, wherein the first threshold is a threshold in a first direction of the compliant displacement from the actuated position, wherein the controller is further configured for taking an intervening action when the compliant displacement exceeds a second threshold, wherein the second threshold is a threshold in a second direction, opposite to the first direction, wherein the value of the first and the second threshold differ from each other.

9. Device according to claim 6, wherein at least one of the first threshold and the second threshold is a function of a momentary speed at which the actuated and/or compliant displacement takes place.

10. Device according to claim 1, comprising at least one sensor for determining the actual position and/or determining the compliant displacement of the non-stationary member.

11. (canceled)

12. Device according to claim 8, wherein the controller assembly is configured for determining the compliant displacement of the non-stationary member based on a signal or on data generated by the at least one sensor.

13. (canceled)

14. Device according to claim 1, further comprising an array of sensors, wherein a first sensor is configured for providing a signal or data that represents the actual position and/or determines proximity of the non-stationary member, and wherein a second sensor is configured for providing a signal or data that represents the compliant displacement of the non-stationary member or a force exerted on the non-stationary member in a direction substantially along the direction of the compliant displacement.

15. Method for operating a device for connecting a connector of an electric vehicle charger to a socket of an electric vehicle, the device comprising:
a stationary member that;
forms part of a fixed world and/or the vehicle charger and/or an actuated mechanism;
a non-stationary member:
for carrying a connector;
that is displaceable with respect to the stationary member along respective lines substantially parallel to each other by means of both:
i. an actuated displacement from a default position to an actuated position; and
ii. a superimposed compliant displacement from the actuated position to an actual position;
at least one controllable actuator for accomplishing the actuated displacement;
a compliance assembly for accomplishing the compliant displacement;
the method comprising:
controlling the controllable actuator;
determining the actual position; and
determining the compliant displacement of the non-stationary member; and
taking an intervening action when the compliant displacement exceeds a first threshold, wherein the
first threshold is a non-constant function of the actuated position.

16. Device according to claim 1, wherein the compliance assembly comprises at least two compliance elements, wherein a first compliance element is configured to provide a compliant displacement in a first direction and a second compliance element is configured to provide a compliant displacement in a second direction opposite to the first direction.

17. Device according to claim 16, wherein the compliance assembly is configured such that a stiffness of the first and second compliance elements is different.

18. Device according to claim 1, wherein the actuator is compliantly coupled to the stationary member by a compliant element, and is compliantly displaceable by a force exerted on the non-stationary member to which the actuator is mechanically coupled.

19. Device according to claim 18, wherein the compliant element provides the actuator with a compliant displacement in one degree of freedom.

20. Device according to claim 16, wherein the compliance elements are configured to allow a non-linear response to compliant displacement, such that the reactive force increases or decreases non-linearly with the magnitude of the compliant displacement.
